(19) United States
(12) Patent Application Publication
(10) Pub. No.: US 2008/0089070 A1
(43) Pub. Date: Apr. 17, 2008

(54) LED LAMP MODULE WITH ADJUSTABLE ILLUMINATING ANGLE

(76) Inventor: Chin-Wen Wang, Pingzhen city (TW)

Correspondence Address: HDSL, 4331 STEVENS BATTLE LANE, FAIRFAX, VA, 22033, US

(21) Appl. No.: 11/548,729

(22) Filed: Oct. 12, 2006

(51) Int. Cl. F21V 29/00

(52) U.S. Cl. 362/294; 362/373; 362/390

(57) ABSTRACT

An exemplary LED lamp module includes an LED lamp, a fixed base, and a plurality of elastic member. The LED lamp includes a base and an LED module. The base includes a plurality of connecting portions, and the fixed base includes a plate and a plurality of fixed poles corresponding to the connecting portions so as to form a space therebetween for accommodating the LED lamp. Each of the fixed poles includes a plurality of locating grooves. One end of each of the elastic member is connected to the connecting portions of the base, and the other end of each of the elastic member is adjustably fixed to the locating grooves of the fixed poles. The illuminating angle of the LED module may be conveniently adjusted according to different height of the lamp post and the different of the angles between the LED lamp modules relative to the ground.

### BACKGROUND

The present invention relates to lamps, and more particularly to a light emitting diode (LED) lamp module, the illuminating angle of the LED lamp module is adjustable.

Because of the advantages of high brightness, lower power consumed and long used life, LEDs are widely used in all kinds of illuminative lamps. Generally, the LEDs are aligned on a circuit board to form an LED module, and the LEDs of the LED module are serially or parallel connected to form the LED lamp having great illuminative range. The LED lamp may be employed in the street lamps.

Laid open Taiwan Patent No. M292042 disclosed a street lamp having a lamp module and a lamp post supporting the lamp module. The lamp module includes a top cover, a light-penetrating mirror disposed under and connected to the top cover, a dividing plate disposed between the top cover and the light-penetrating mirror that is connected to the top cover, an LED module fixed to the bottom surface of the dividing plate, and a heat pipe fixed to the top surface of the dividing plate. The LED module includes a circuit board and a plurality of LEDs disposed on the circuit board.

However, the conventional lamp module has following disadvantages. Firstly, the height of the lamp posts are different when the street lamp being employed in different illuminating situations, the LEDs of the lamp module may only illuminate single direction for the reason of limited emitting angle, then the brightness in the illuminating range are uneven when the lamp module engaged with lamp posts in different height. Secondly, the lamp module may maintain different angles relative to the ground, which may also impact the uniformity of the brightness in the illuminating range. Thirdly, the lamp module use the heat pipe for dispersing heat, which has limited attached area between the heat pipe and the LED module, then the ability of heat dispersing of the heat pipe is limited.

Accordingly, what is needed is an LED lamp module that can overcome the above-described deficiencies.

### BRIEF SUMMARY

An exemplary LED lamp module is moveably fixed to a fixed pole via an elastic member, which is able to adjust the illuminating angle according to different illuminating situations for achieving even brightness in illuminating range.

The LED lamp module includes an LED lamp, a fixed base, and a plurality of elastic member. The LED lamp includes a base and an LED module disposed below the base. The base includes a plurality of connecting portions, and the fixed base includes a plate and a plurality of fixed poles connected with the plate and corresponding to the connecting portions so as to form a space for accommodating the LED lamp. Each of the fixed poles includes a plurality of locating grooves. One end of each of the elastic member is connected to the connecting portions of the base, and the other end of each of the elastic member is adjustably fixed to the locating grooves of the fixed poles.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective, exploded view of an LED lamp module according to an exemplary embodiment of the present invention;

FIG. 2 is a perspective, partly assembly view of the LED lamp module of FIG. 1;

FIG. 3 is a perspective, assembly view of the LED lamp module of FIG. 1;

FIG. 4 is a cross-sectional view of the LED lamp module of FIG. 1;

FIG. 5 is an assembly, cross-sectional view of a street lamp employing the LED lamp module of FIG. 1; and

FIG. 6 is a schematic view of operation states of the LCD lamp module of FIG. 5.

### DETAILED DESCRIPTION

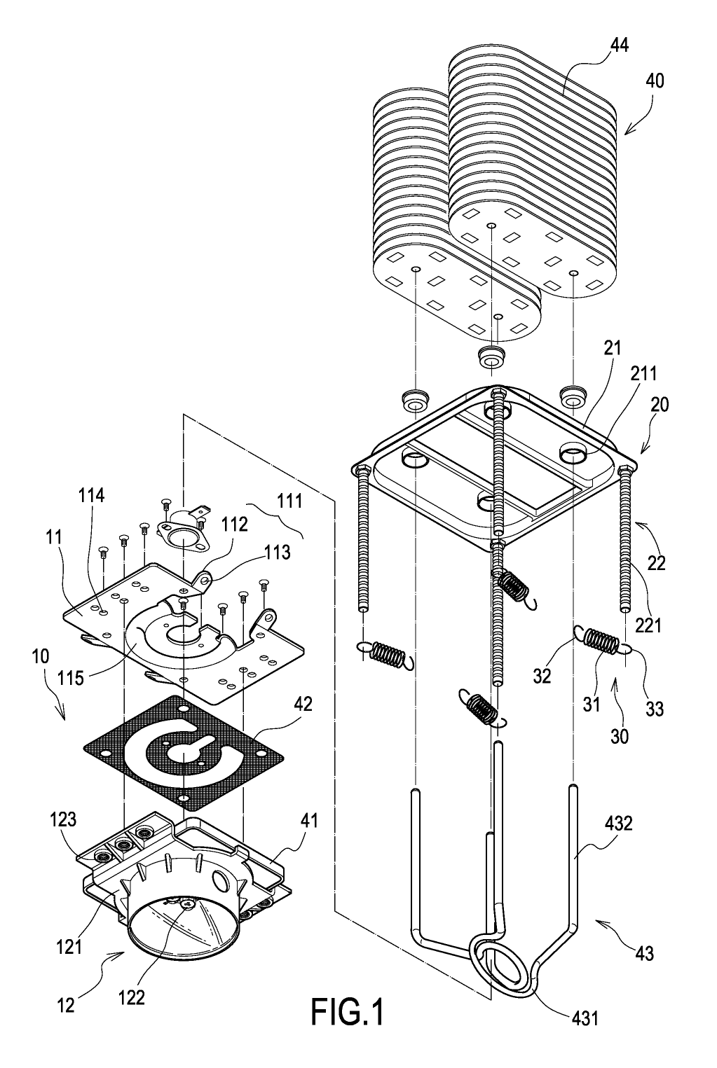

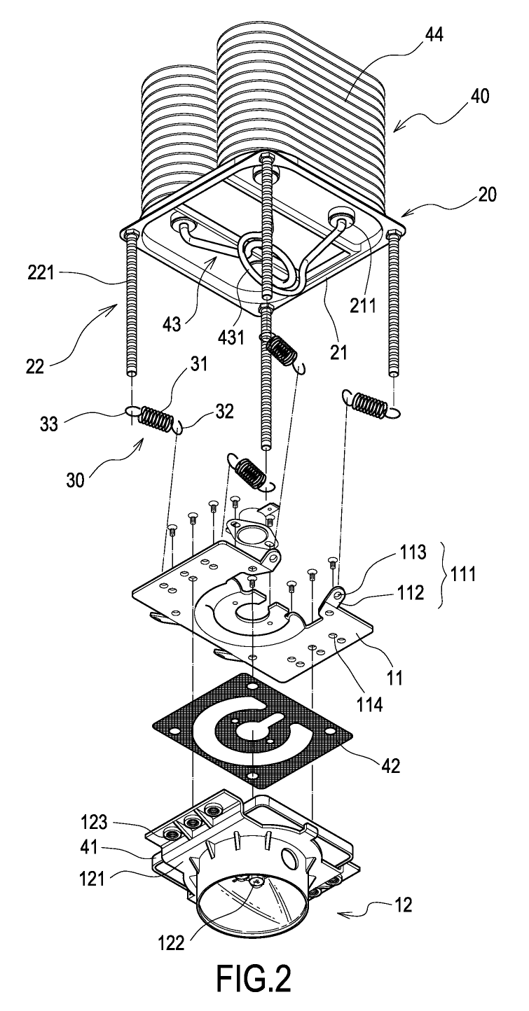

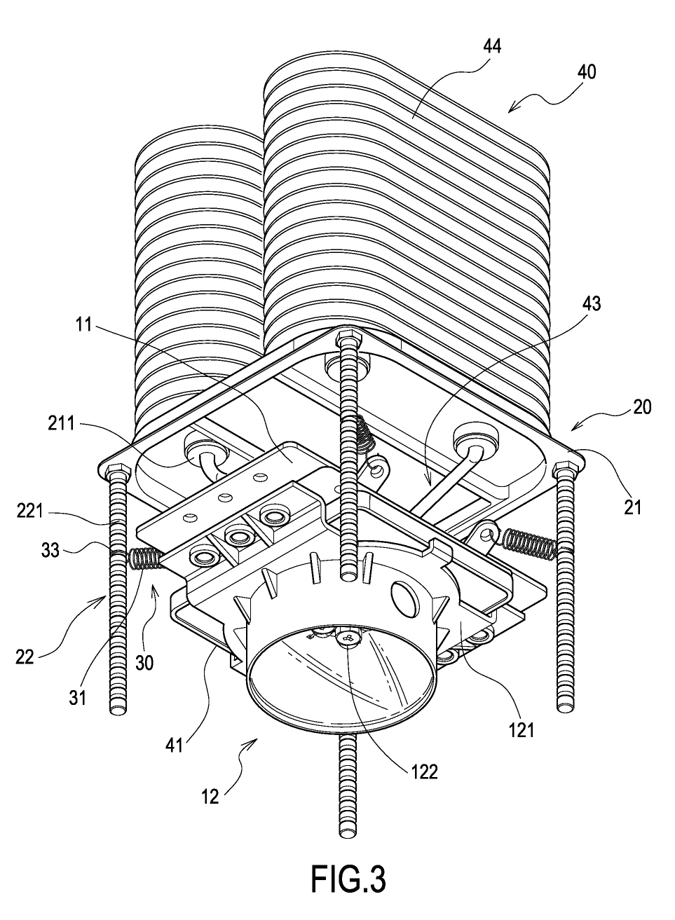

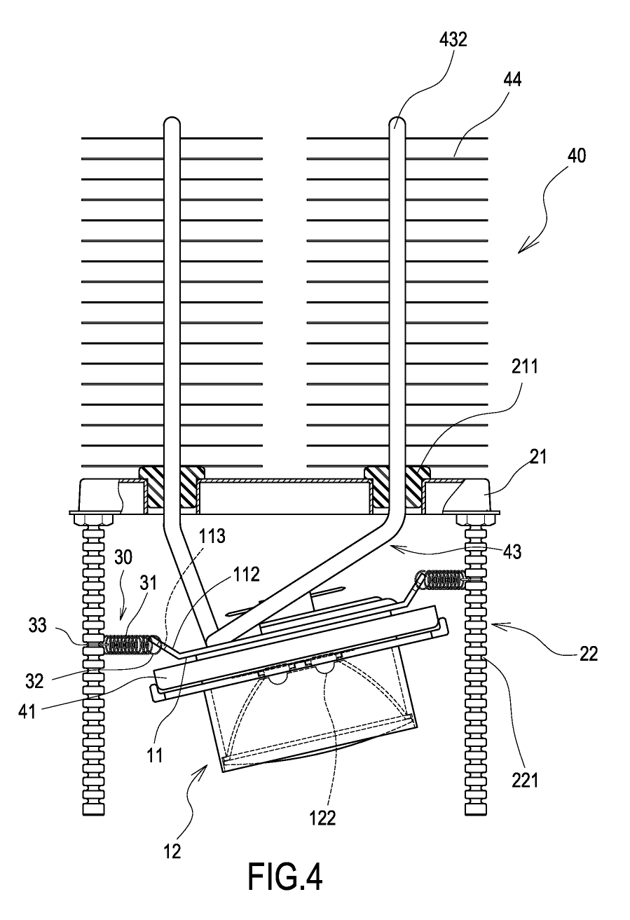

Referring to FIGS. 1 to 4, FIG. 1 is a perspective, exploded view of an LED lamp module according to an exemplary embodiment of the present invention, FIG. 2 is a perspective, partly assembly view of the LED lamp module of FIG. 1, FIG. 3 is a perspective, assembly view of the LED lamp module of FIG. 1, and FIG. 4 is a cross-sectional view of the LED lamp module of FIG. 1. The LED lamp module includes an LED lamp 10, a fixed base 20, and a plurality of elastic members 30.

The LED lamp 10 includes a rectangle plate-shaped base 11 and an LED module 12. The base 11 includes a plurality of connecting portions 111 disposed at front and rear portions thereof, which may be ear portions 112 and holes 113 as shown in FIG. 1. The base 11 further includes a plurality of through holes 114 disposed at left and right portions thereof, and an arc-shaped groove 115 disposed at a middle portion of a bottom surface thereof. The LED module 12 includes a cover 121, a plurality of LEDs 122 disposed in the cover 121, and a plurality of screw holes 123 corresponding to the through holes 114 for being fixed with the through holes 114 by screws.

The fixed base 20 includes a rectangle plate 21 and a plurality of fixed poles 22 connected at four corners of the plate 21. The plate 21 includes a plurality of through holes 211, and the fixed poles 22 are corresponded to the connecting portions 111 to form a space therebetween for accommodating the LED lamp 10 therein. Each of the fixed poles 22 includes locating grooves 221 alternatively disposed, and the distance between each two locating grooves are the same.

The elastic member 30 may be a spiral spring having spiral portion 31 and two hooks 32 and 33 respectively connected to two ends of the spiral portion 31. The hook 32 is engaged with the hole 113 of the connecting portion 111, and the hook 33 is adjustably fixed to the locating groove 221 of the fixed pole 22.

Moreover, the LED lamp module further includes a heat sink 40, which includes a heat spreading plate 41, a soft cushion 42, a plurality of heat pipe 43, and a plurality of heat sink plates 44. The heat spreading plate 41 is fixed to the top portion of the cover 121, and the rear sides of each of the LEDs 122 are attached to the heat spreading plate 41. The soft cushion 42 is disposed between the base 11 and the side surface of the heat spreading plate 41. Each of the heat pipes 43 includes a circular heat transfer end 431 and a vertical heat discharged end 432. The heat transfer ends 431 are fixed between the arc-shaped groove 115 of the base 11 and the rear side of the heat spreading plate 41. The heat discharged ends 432 extend through the through holes 211 of the plate 21 and connect to the heat sink plates 44. The heat spreading plate 41 may greatly attaches to the LED module 12, and the heat pipe 43 may function as long-distance heat discharged element so at to greatly improved the efficiency of heat sink. Therefore, the term of using the LEDs 122 may extend.

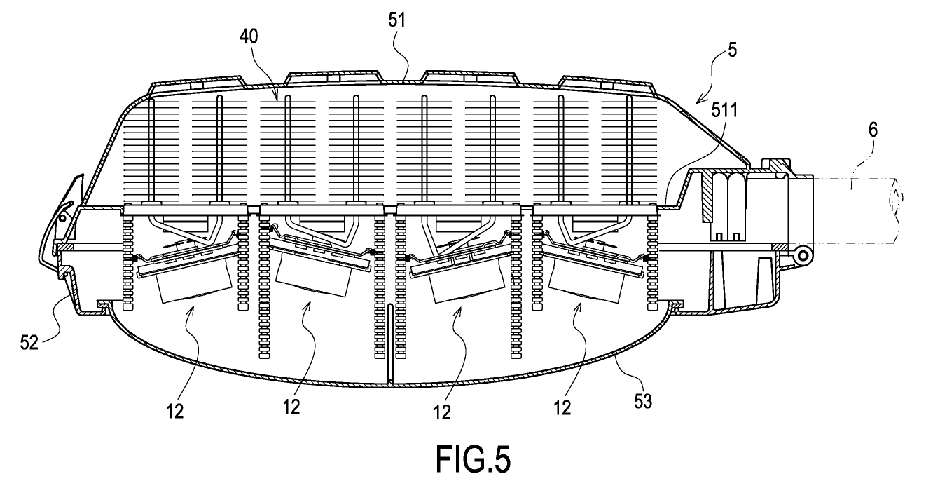

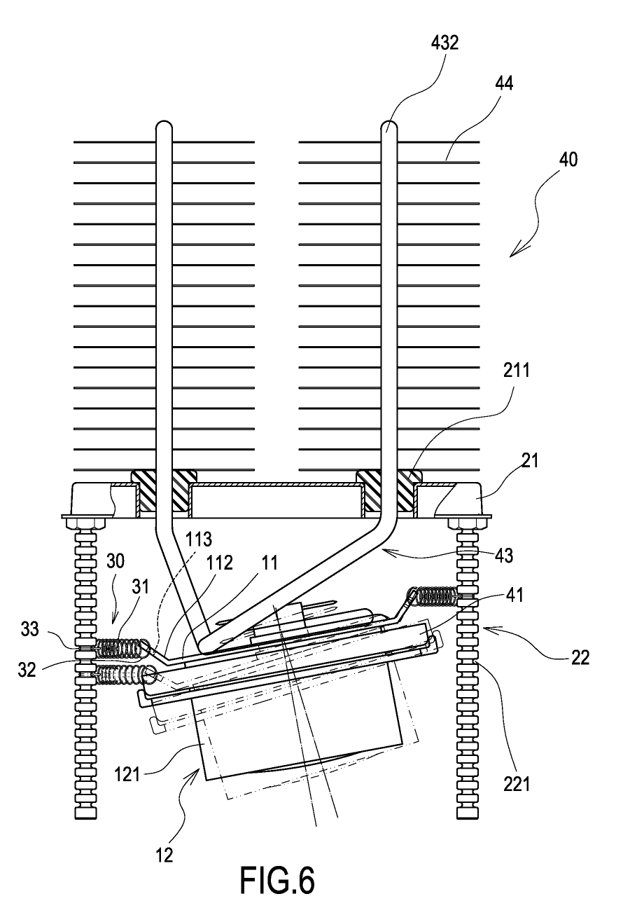

Also referring to FIGS. 5 and 6, FIG. 5 is an assembly, cross-sectional view of a street lamp employing the LED lamp module; and FIG. 6 is a schematic view of operation states of the LCD lamp module of FIG. 5. The street lamp 5 is engaged with an end of a lamp post 6, which includes a top cover 51, a bottom cover 52 connected to the top cover 51, and a light-penetrating mirror 53 attached to a bottom edge of the bottom cover 52. The top cover 51 includes a supporting plate 511 therein for fixing a plurality of LED lamp module. When adjusting the illuminating angle of the LED lamp modules, the screws connecting the base 11 and the LED module 12 are released firstly; then the hooks 33 of the elastic member 30 are up or down moved along the fixed poles 22 to incline the base 11 and the LCD module 12 together; after that, the hooks 33 are fixed to the selected locating groove 221 of the fixed poles 22; finally, the screws described-above are fixed.

With these configurations, the illuminating angle of the LED modules 12 may be conveniently adjusted according to different height of the lamp post 6 and the different of the angles between the LED lamp modules relative to the ground.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An LED lamp module, comprising:
an LED lamp comprising a base and an LED module disposed under the base, the base having a plurality of connecting portions;
a fixed base comprising a plate and a plurality of fixed poles connected with the plate, each of the fixed poles is respectively corresponded to the connecting portions and to form a space between the fixed poles and the connecting portions, each of the fixed poles comprising a plurality of locating grooves thereon; and
a plurality of elastic members, one end of each of the elastic member being connected to the connecting portions of the base, and the other end of each of the elastic members is adjustably fixed to the locating grooves of the fixed poles.

2. The LED lamp module as claimed in claim 1, wherein the connecting portions comprises an ear portion and a hole.

3. The LED lamp module as claimed in claim 2, wherein the elastic member is a spiral spring having spiral portion and two hooks respectively connected to two ends of the spiral portion, one hook is engaged with the hole of the connecting portion, and the other hook is adjustably fixed to the locating groove of the fixed pole.

4. The LED lamp module as claimed in claim 3, wherein a distance between each two locating grooves are the same.

5. The LED lamp module as claimed in claim 1, wherein the LED module comprises a cover and a plurality of LEDs disposed in the cover.

6. The LED lamp module as claimed in claim 5, wherein the base further comprises a plurality of through holes disposed at two sides thereof, and the cover comprises a plurality of through holes disposed at two sides thereof corresponding to the through holes of the base for inserting screws.

7. The LED lamp module as claimed in claim 5, further comprising a heat sink, which includes a heat spreading plate and a soft cushion, wherein the heat spreading plate is fixed to the top portion of the cover, and the rear sides of each of the LEDs are attached to the heat spreading plate, the soft cushion is disposed between the base and the side surface of the heat spreading plate.

8. The LED lamp module as claimed in claim 7, the heat sink further comprises a plurality of heat pipe and a plurality of heat sink plates, each of the heat pipes comprises a circular heat transfer end and a vertical heat discharged end, the heat transfer ends are fixed between the base and the rear side of the heat spreading plate, and the heat discharged ends extend through the plate for connecting to the heat sink plates.
